(19) United States
(12) Patent Application Publication
(10) Pub. No.: US 2009/0009499 A1
(43) Pub. Date: Jan. 8, 2009

(54) Plasma display, controller therefor and driving method thereof

(76) Inventors: Jang-Ho Moon, Suwon-si (KR); Jung-Jin Choi, Suwon-si (KR); Youn-Kyoung Kim, Suwon-si (KR); Hyun Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/222,204

(22) Filed: Aug. 5, 2008

(30) Foreign Application Priority Data
Jul. 8, 2007 (KR) 10-2007-0079033

(51) Int. Cl. G09G 5/00; G09G 3/28

(52) U.S. Cl. 345/205; 345/60

(57) ABSTRACT

A plasma display, a controller therefor and a method of driving determines a screen load ratio from a plurality of video signals input during one frame, and determines a total number of sustain pulses according to the screen load ratio. A ratio of overlap sustain pulses to non-overlap sustain pulses is determined according to a first load ratio, and the overlap and non-overlap sustain pulses are arranged according to the determined ratio. The first load ratio may be the screen load ratio or a display load ratio. The arranged sustain pulses are applied to a plurality of first and second electrodes that perform a display operation during a sustain period.

### BACKGROUND OF THE INVENTION

1. Field of the Invention

Embodiments relate to a plasma display, a controller therefor, and a driving method thereof.

2. Description of the Related Art

A plasma display panel (PDP) is a flat panel display that uses plasma generated by gas discharge to display characters or images. The PDP includes a plurality of discharge electrode pairs and a plurality of address electrodes crossing the plurality of discharge electrode pairs.

One frame of the plasma display is divided into a plurality of subfields to drive the plasma display. Turn-on/turn-off cells (i.e., cells to be turned on or off) are selected during an address period of each subfield. A sustain discharge occurs for a number of times corresponding to a luminance weight of a corresponding subfield in the light emitting cells during a sustain period of each subfield. During the sustain period, sustain pulses, alternately having a high level voltage and a low level voltage and having opposite phases, are applied to the discharge electrode pairs. When the high level voltage of the sustain pulse is changed to the low level voltage, a self-erase discharge is generated between an address electrodes and one of the discharge electrodes of a corresponding discharge electrode pair before the sustain discharge is generated between the two electrodes. As a result, some wall charges may be erased. Accordingly, a subsequent sustain discharge may not be appropriately generated and the amount of wall charges may vary in the turn-on cells and the turn-off cells. Therefore, an after-image effect or discharge spots may occur.

The above information disclosed in this Background section is only for enhancement of understanding of the background of the invention and therefore it may contain information that does not form prior art that is already known in this country to a person of ordinary skill in the art.

### SUMMARY OF THE INVENTION

Embodiments of the present invention are therefore directed to a plasma display, a controller therefor, and a driving method thereof, which substantially overcome one or more of the problems due to the limitations and disadvantages of the related art

An embodiment of the present invention may provide a plasma display, a controller therefor, and driving method that may prevent an after-image effect.

Another embodiment of the present invention may provide a plasma display, a controller therefor, and driving method that may prevent discharge spots.

Still another embodiment of the present invention may provide a plasma display, a controller therefor, and driving method that may appropriately generate a sustain discharge.

At least one of the above and other advantages may be realized by providing a method for driving a plasma display while dividing one frame into a plurality of subfields respectively having weight values in a plasma display including a plurality of discharge cells, the method including calculating a screen load ratio from a plurality of video signals input during one frame, determining a total number of sustain pulses during the frame according to the screen load ratio, determining a ratio of overlap sustain pulses to non-overlap sustain pulses according to a first load ratio, and arranging the sustain pulses allocated to each subfield as the overlap sustain pulses and the non-overlap sustain pulses according to the determined ratio.

At least one of the above and other advantages may be realized by providing plasma display, including a plurality of discharge cells, a controller configured to divide one frame into a plurality of subfields, calculate a screen load ratio from video signals of the frame, determine a ratio of overlap sustain pulses and non-overlap sustain pulses in the plurality of subfields according to the a first load ratio, and arrange the sustain pulses allocated to the plurality of subfields as the overlap sustain pulses and the non-overlap sustain pulses based on the determined ratio, and a driver for sequentially applying the arranged sustain pulses to the plurality of discharge cells in the respective subfields.

At least one of the above and other advantages may be realized by providing a method for driving a plasma display while dividing one frame into a plurality of subfields in a plasma display including a first electrode and a second electrode performing a display operation together, the driving method including applying a plurality of first sustain pulses to the first electrode in a sustain period, and applying a plurality of second sustain pulses to the second electrode while having an opposite phase to that of the first sustain pulse in the sustain period, wherein, the plurality of first and second sustain pulses are grouped into a plurality of groups according to a pulse type, the first and second sustain pulses of a first group, which includes the first sustain pulse that is firstly applied to the first electrode in the sustain period, partially overlap, and the first and second sustain pulses of a second group among the plurality of groups do not overlap, and the number of first and second sustain pulses included in the first group varies according to a first load ratio.

At least one of the above and other advantages may be realized by providing a controller for use with a plasma display device, the controller including a dividing unit configured to divide one frame into a plurality of subfields, a screen load unit configured to calculate a screen load ratio from video signals of the frame, a ratio unit configured to determine a ratio of overlap sustain pulses and non-overlap sustain pulses in the plurality of subfields according to a load ratio, and an arranging unit configured to arrange the sustain pulses allocated to the plurality of subfields as the overlap sustain pulses and the non-overlap sustain pulses based on the determined ratio.

The first load ratio may be the calculated screen load ratio or a calculated display load ratio. The ratio may increase the ratio of the overlap sustain pulses to the non-overlap sustain pulses when the first load ratio increases. The sustain pulses may be arranged such that the overlap sustain pulses at the determined ratio are followed by the non-overlap sustain pulses at the determined ratio for a number of sustain pulses for each subfield.

Each sustain pulse may have a high level voltage and a low level voltage, each overlap sustain pulse may have a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage, and each non-overlap sustain pulse may not have a period in which a third sustain pulse applied to the plurality of discharge cells overlaps with a fourth sustain pulse applied to the plurality of discharge cells immediately after the third sustain pulse.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display according to an exemplary embodiment of the present invention;

FIG. 2 illustrates a sustain pulse according to an exemplary embodiment of the present invention;

FIG. 3 illustrates a block diagram of a controller according to a first exemplary embodiment of the present invention;

FIG. 4 illustrates a flowchart of an operation of the controller according to the first exemplary embodiment of the present invention;

FIG. 5 illustrates a ratio of overlap sustain pulses to non-overlap sustain pulses versus a screen load ratio;

FIG. 6A and FIG. 6B illustrate sustain pulses arranged by the controller according to the first exemplary embodiment of the present invention; and

FIG. 7 illustrates a block diagram of a controller according to a second exemplary embodiment of the present invention.

### DETAILED DESCRIPTION OF THE INVENTION

Korean Patent Application No. 10-2007-0079033, filed on Aug. 7, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals designate like elements throughout the specification.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art.

A plasma display and a driving method thereof according to exemplary embodiments of the present invention will be described.

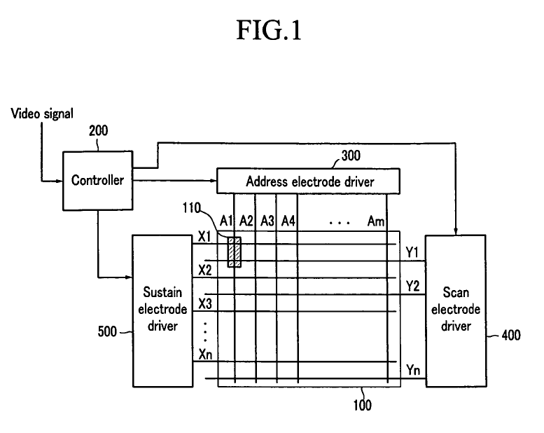

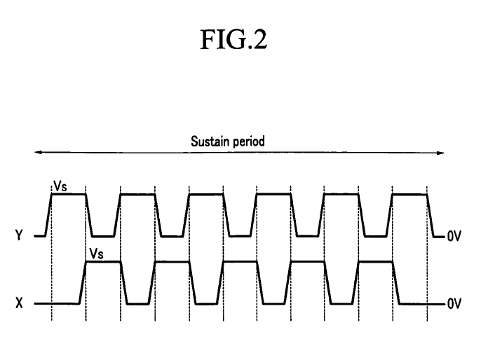

FIG. 1 illustrates a diagram of the plasma display according to an exemplary embodiment of the present invention. FIG. 2 illustrates a diagram representing a sustain pulse according to an exemplary embodiment of the present invention.

As illustrated in FIG. 1, the plasma display may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain and scan electrodes X1 to Xn and Y1 to Yn extending in a row direction in pairs. In general, the sustain electrodes X1 to Xn may correspond to the scan electrodes Y1 to Yn, respectively. The sustain electrodes and scan electrodes may perform a display operation for displaying an image during a sustain period. The scan electrodes Y1 to Yn and the sustain electrodes X1 to Xn may cross the address electrodes A1 to Am. Discharge spaces at crossing regions of the address electrodes A1 to Am and the sustain and scan electrodes X1 to Xn and Y1 to Yn form discharge cells 110. It is to be noted that the above construction of the PDP is only an example, and panels having different structures may employ driving waveforms to be described below according to embodiments.

The controller 200 may receive an external video signal, and output an address electrode driving control signal, a sustain electrode driving control signal, and a scan electrode driving control signal. The address electrode driver 300 may apply a driving voltage to the plurality of A electrodes A1 to Am according to the driving control signal from the controller 200. The scan electrode driver 400 may apply a driving voltage to the plurality of Y electrodes Y1 to Yn according to the driving control signal from the controller 200. The sustain electrode driver 500 may apply a driving voltage to the plurality of X electrodes X1 to Xn according to the driving control signal from the controller 200.

In further detail, the address, scan, and sustain electrode drivers 300, 400, and 500 may select light emitting cells and non-light emitting cells in a corresponding subfield from among the plurality of discharge cells 110 during the address period of each subfield.

During the sustain period of each subfield, as illustrated in FIG. 2, the scan electrode driver 400 may apply a sustain pulse alternately having a high level voltage Vs and a low level voltage 0V to the plurality of Y electrodes Y1 to Yn a number of times corresponding to a weight value of the corresponding subfield. In addition, the sustain electrode driver 500 may apply a sustain pulse having an opposite phase to that of the Y electrodes Y1 to Yn to the plurality of X electrodes X1 to Xn. Thereby, a difference between each Y electrode and each X electrode may alternately be a Vs voltage and a −Vs voltage. Therefore, a sustain discharge may be repeatedly generated in a turn-on discharge cell a predetermined number of times.

As may be seen in FIG. 2, when the sustain pulse applied to the Y electrode during the sustain period partially overlaps the sustain pulse applied to the X electrode immediately after the sustain pulse applied to the Y electrode during the sustain period. That is, while the Vs voltage is applied to the X electrode, a voltage at the Y electrode decreases from the Vs voltage to the 0V voltage for a predetermined time after the Vs voltage is applied to the X electrode. In a like manner, while the Vs voltage is applied to the Y electrode, a voltage at the X electrode decreases from the Vs voltage to the 0V voltage for a predetermined time after the Vs voltage is applied to the Y electrode. Accordingly, since the A electrode becomes a cathode with respect to the Y electrode (or the X electrode), a discharge between the Y and X electrodes may be generated earlier than a self-erase discharge between the Y electrode (or the X electrode) and the A electrode.

Discharge in a cell is determined by the amount of secondary electrons emitted from the cathode when positive ions collide against the cathode, which is referred to as a γ process. In the PDP, phosphor may cover the A electrodes to express colors, and a protective layer, e.g., a layer made of materials having a high secondary electron emission coefficient such as an MgO, may cover the X and Y electrodes to increase sustain discharge efficiency. Accordingly, since the A electrode covered with the phosphor functions as the cathode when a voltage between the A and Y electrodes exceeds a discharge firing voltage, the discharge between the A electrode and the Y electrode (or the X electrode) is delayed. Thereby, the self-erase discharge may be generated between the A electrode and the Y electrode (or the X electrode) while the voltage at the Y electrode (or the X electrode) decreases from the Vs voltage to the 0V voltage, and the sustain discharge is generated between the X and Y electrodes before the wall charges are eliminated. Accordingly, an after-image effect or discharge spots may be prevented, and a subsequent sustain discharge may be stably generated.

However, when the sustain pulse illustrated in FIG. 2 is applied during the sustain period, damage to the protective layer covering the Y and X electrodes may be increased. Accordingly, a life-span of the PDP may be reduced, and a luminance maintenance rate may be considerably deteriorated.

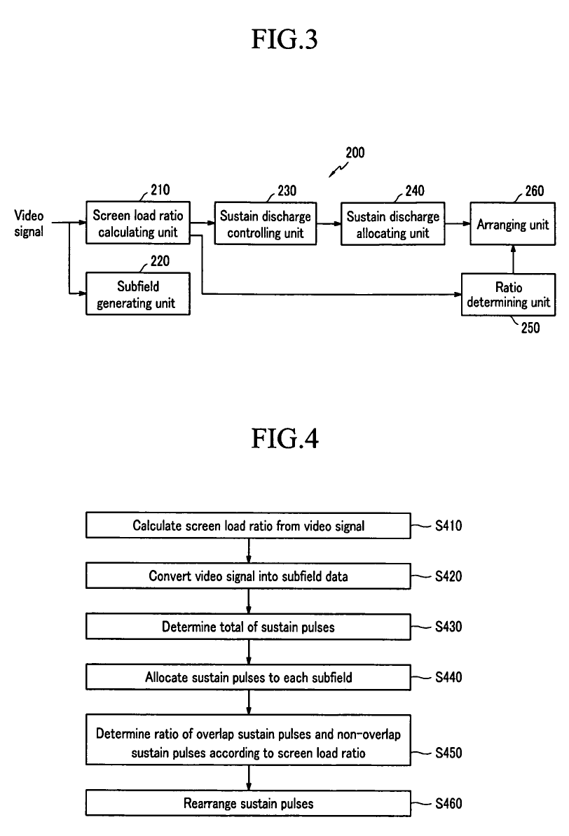

A first exemplary embodiment of the present invention for preventing deterioration of the luminance maintenance rate and the self-erase discharge will be described with reference to FIG. 3 to FIG. 6B. Hereinafter, the sustain pulse will be referred to as an “overlap sustain pulse” when the sustain pulse applied to the Y electrode overlaps the sustain pulse applied to the X electrode, i.e., when both the Y electrode and the X electrode are at the Vs voltage simultaneously. The sustain pulse will be referred to as a “non-overlap sustain pulse” when the sustain pulse applied to the Y electrode does not overlap the sustain pulse applied to the X electrode, i.e., when the Y electrode and the X electrode are never at the Vs voltage simultaneously.

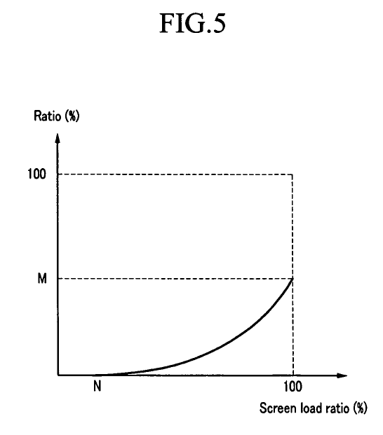

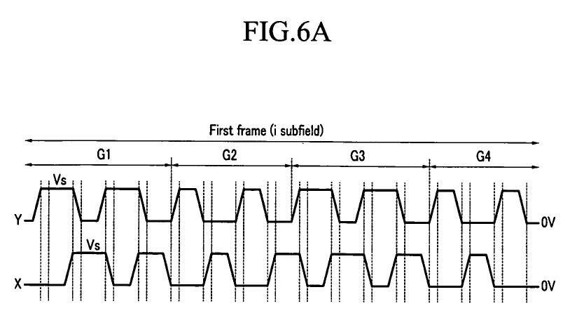

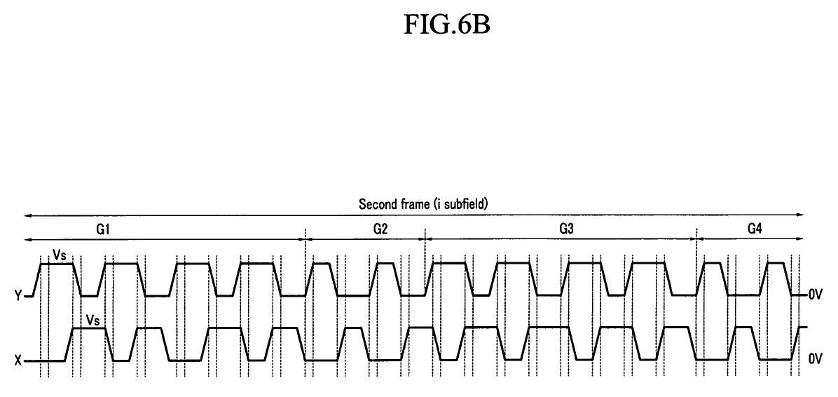

FIG. 3 illustrates a block diagram of a controller 200 according to a first exemplary embodiment of the present invention, FIG. 4 illustrates a flowchart of operation of the controller 200 according to the first exemplary embodiment of the present invention, and FIG. 5 illustrates a ratio of the overlap sustain pulses to the non-overlap sustain pulses versus a screen load ratio. In addition, FIG. 6A and FIG. 6B illustrate sustain pulses arranged by the controller 200 according to embodiments of the present invention.

As illustrated in FIG. 3, the controller 200 according to the first exemplary embodiment of the present invention may include a screen load ratio calculating unit 210, a subfield generating unit 220, a sustain discharge controlling unit 230, a sustain discharge allocating unit 240, a ratio determining unit 250, and an arranging unit 260.

The screen load ratio calculating unit 210 may calculate a screen load ratio from the plurality of video signals input for one frame in operation S410. For example, the screen load ratio calculating unit 210 may calculate the screen load ratio from an average signal level (ASL) of the video signals of one frame as given in Equation 1. Here, the plurality of video signals respectively correspond to the plurality of discharge cells 110 illustrated in FIG. 1.

$$ASL = ( {\sum }_{V} {R}_{n} + {\sum }_{V} {G}_{n} + {\sum }_{V} {B}_{n} ) / 3 N \qquad [ Equation 1 ]$$

In Equation 1, Rₙ, Gₙ, and Bₙ respectively denote gray levels of R, G, and B image data, V denotes one frame, and 3N denotes the number of R, G, and B image data input for one frame.

The subfield generating unit 220 may convert the plurality of video signals into a plurality of subfield data in operation S420.

The sustain discharge controlling unit 230 may determine a total number of sustain pulses allocated to one frame, according to the screen load ratio in operation S430. In this case, the sustain discharge controlling unit 230 may store the total number of sustain pulses determined according to the screen load ratio in a look-up table, or may calculate the total number of sustain pulses by performing a logic operation on the data corresponding to the screen load ratio. Thus, when the number of light emitting cells is increased, thus increasing the screen load ratio, the total number of sustain pulses may be decreased to prevent an increase of power consumption.

The sustain discharge allocating unit 240 may respectively allocate the sustain pulses in proportion to the luminance weight values in operation S440.

The ratio determining unit 250 may determine a ratio of the overlap sustain pulses and the non-overlap sustain pulses according to the calculated screen load ratio in operation S450. In general, since a discharge current in a frame having a low screen load ratio is less than the discharge current in a frame having a high screen load ratio, the frame having the low screen load ratio has a lower probability in generating an after-image and discharge spots. The ratio of the overlap sustain pulses to the non-overlap sustain pulses may be stored in a look-up table.

Accordingly, the ratio determining unit 250 may increase a ratio of the overlap sustain pulses to the non-overlap sustain pulses as the screen load ratio increases, as illustrated in FIG. 5. That is, the ratio determining unit 250 may establish the ratio of the overlap sustain pulses to the non-overlap sustain pulses to be 0, i.e., no overlap sustain pulses are used, when the screen load ratio is less than N %, and may gradually increase to a predetermined ratio, e.g., the ratio may be increased from 0 to M % when the screen load ratio is greater than N %. M is an integer less than 100, e.g., 50.

The arranging unit 260 may determine an arrangement of sustain pulses for each subfield according to the ratio determined by the ratio determining unit 250. The overlap sustain pulse(s) may be arranged first. Since the sustain discharge may be generated between the Y and X electrodes before the wall charges are eliminated by the self-erase discharge when the overlap sustain pulse(s) are applied, a strong sustain discharge is generated, and the wall charges may be sufficiently formed on the X and Y electrodes. In addition, after the wall charges are sufficiently formed on the X and Y electrodes, the self-erase discharge is not generated when the non-overlap sustain pulse(s) is subsequently applied to the X and Y electrodes. For example, when the number of sustain pulses applied to one subfield is twenty, the ratio of the overlap sustain pulses to the non-overlap sustain pulses may be 4:2. Thus, the arranging unit 260 may arrange four overlap sustain pulses, followed by two non-overlap sustain pulses, followed again by four overlap sustain pulses, until twenty sustain pulses have been arranged. Accordingly, the arranging unit 260 arranges the twenty allocated sustain pulses. Then, the arranging unit 260 may apply driving control signals according to the arranged sustain pulses to the scan and sustain electrode drivers 400 and 500.

Here, each sustain pulse (for both the overlap and non-overlap sustain pulses) may include applying a first sustain pulse to the Y electrode and a second sustain pulse, subsequent to the first sustain pulse, to the X electrode. In other words, each sustain pulse may have a high level voltage and a low level voltage. Each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage. Each non-overlap sustain pulse does not have a period in which a third sustain pulse applied to the plurality of discharge cells overlaps a fourth sustain pulse applied to the plurality of discharge cells immediately after the third sustain pulse.

Referring to FIG. 6A and FIG. 6B, the controller 200 may arrange the ratio of the allocated sustain pulses to be 2:2 in an i subfield of a first frame having a relatively low screen load ratio, and arrange the ratio of the allocated sustain pulses to be 4:2 in an i subfield of a second frame having a relatively high screen load ratio, where i is an integer greater than 0. As described, the arranged sustain pulses are applied to the X and Y electrodes during the sustain period of the i subfield.

In the sustain period of the i subfield, the sustain pulses applied to the X and Y electrodes during the sustain period of the i subfield may be divided into a plurality of groups G1 to G4, as illustrated in FIGS. 6A and 6B, according to the overlap sustain pulse and the non-overlap sustain pulse. In this case, the overlap sustain pulses are applied to a first group G1. Accordingly, since the sustain discharge is sufficiently generated between the X and Y electrodes as described above before the wall charges are eliminated by the self-erase discharge, the wall charges may be sufficiently formed on the X and Y electrodes.

In addition, in the first exemplary embodiment of the present invention, the ratio of overlap sustain pulses to non-overlap sustain pulses is determined according to the screen load ratio of one frame. Alternatively, the ratio overlap to non-overlap sustain pulses may be determined according to a display load ratio of one frame, as discussed below.

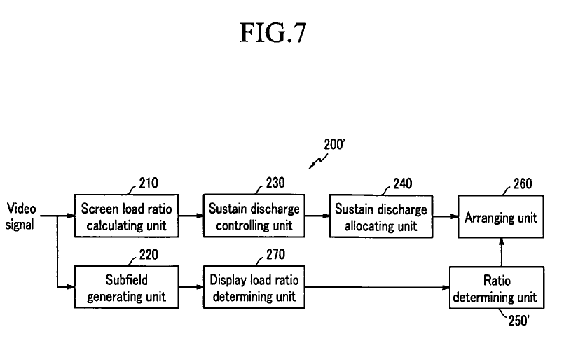

FIG. 7 illustrates a block diagram of a controller 200′ according to a second exemplary embodiment of the present invention.

As illustrated in FIG. 7, the controller 200′ according to the second exemplary embodiment of the present invention is the same as the controller 200 of the first exemplary embodiment of the present invention, except for a ratio determining unit 250′ and a display load ratio calculating unit 270. The display load ratio calculating unit 270 may determine a display load ratio of a corresponding subfield from a ratio of the total number of discharge cells in each subfield and the number of light emitting cells in each subfield. The ratio determining unit 250′ may determine the ratio of the overlap sustain pulses and the non-overlap sustain pulses according to the display load ratio of the corresponding subfield. In particular, the ratio determining unit 250′ may increase the ratio of the overlap sustain pulses to the non-overlap sustain pulses as the display load ratio increases. That is, when the calculated display load ratio of an i^{th} subfield is less than the display load ratio of an (i+1)^{th} subfield, the ratio determining unit 250′ may set the ratio of the overlap sustain pulses to the non-overlap sustain pulses in the i^{th} subfield to be less than the ratio in the (i+1)^{th} subfield.

According to exemplary embodiments of the present invention, the self-erase discharge may be prevented, while the lifespan of the PDP may be extended and the luminance maintenance rate is not redeuced. Accordingly, the after-image effect and discharge spots may be prevented, and the sustain discharge may be appropriately generated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display while dividing one frame into a plurality of subfields respectively having weight values in a plasma display including a plurality of discharge cells, the method comprising:
calculating a screen load ratio from a plurality of video signals input during one frame;
determining a total number of sustain pulses during the frame according to the screen load ratio;
determining a ratio of overlap sustain pulses to non-overlap sustain pulses according to a first load ratio; and
arranging the sustain pulses allocated to each subfield as the overlap sustain pulses and the non-overlap sustain pulses according to the determined ratio.

2. The method as claimed in claim 1, wherein determining the ratio comprises increasing the ratio of the overlap sustain pulses to the non-overlap sustain pulses when the first load ratio increases.

3. The method as claimed in claim 2, wherein arranging the sustain pulses comprises:
arranging the overlap sustain pulses at the determined ratio followed by the non-overlap sustain pulses at the determined ratio; and
alternately arranging the overlap sustain pulses and the non-overlap sustain pulses at the determined ratio for a number of sustain pulses for each subfield.

4. The method as claimed in claim 3, wherein:
each sustain pulse has a high level voltage and a low level voltage,
each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage, and
each non-overlap sustain pulse does not have a period in which a third sustain pulse applied to the plurality of discharge cells overlaps with a fourth sustain pulse applied to the plurality of discharge cells immediately after the third sustain pulse.

5. The method as claimed in claim 2, wherein increasing the ratio of the overlap sustain pulses to the non-overlap sustain pulses is limited to a predetermined ratio.

6. The method as claimed in claim 1, wherein the first load ratio is the calculated screen load ratio.

7. The method as claimed in claim 6, wherein no overlap sustain pulses are used until the calculated screen load ratio exceeds a predetermined amount.

8. The method as claimed in claim 1, the method further comprising:
converting the plurality of video signals input during the frame into a plurality of subfield data; and
calculating a display load ratio of each subfield from subfield data corresponding to a corresponding subfield among the plurality of subfield data in each subfield of the plurality of subfields, wherein the first load ratio is the calculated display load ratio.

9. A plasma display, comprising:
a plurality of discharge cells;
a controller configured to divide one frame into a plurality of subfields, calculate a screen load ratio from video signals of the frame, determine a ratio of overlap sustain pulses and non-overlap sustain pulses in the plurality of subfields according to the a first load ratio, and arrange the sustain pulses allocated to the plurality of subfields as the overlap sustain pulses and the non-overlap sustain pulses based on the determined ratio; and
a driver for sequentially applying the arranged sustain pulses to the plurality of discharge cells in the respective subfields.

10. The plasma display as claimed in claim 9, wherein the controller increases the ratio of the overlap sustain pulses to the non-overlap sustain pulses as the load ratio increases.

11. The plasma display as claimed in claim 10, wherein the controller arranges the overlap sustain pulses according to the determined ratio followed by the non-overlap sustain pulses according to the determined ratio in the respective subfields.

12. The plasma display as claimed in claim 9, wherein:
each sustain pulse has a high level voltage and a low level voltage,
each overlap sustain pulse has a period in which a period for changing a voltage of a first sustain pulse applied to the plurality of discharge cells from the high level voltage to the low level voltage overlaps a period in which a voltage of a second sustain pulse applied to the plurality of discharge cells immediately after the first sustain pulse has the high level voltage, and
each non-overlap sustain pulse does not have a period in which a third sustain pulse applied to the plurality of discharge cells overlaps a fourth sustain pulse applied to the plurality of discharge cells immediately after the third sustain pulse.

13. The plasma display as claimed in claim 9, wherein the first load ratio is the calculated screen load ratio.

14. The plasma display as claimed in claim 9, wherein the controller is further configured to:
convert the plurality of video signals input during the frame into a plurality of subfield data; and
calculate a display load ratio of each subfield from subfield data corresponding to a corresponding subfield among the plurality of subfield data in each subfield of the plurality of subfields, wherein the first load ratio is the calculated display load ratio.

15. A method for driving a plasma display while dividing one frame into a plurality of subfields in a plasma display including a first electrode and a second electrode performing a display operation together, the driving method comprising:
applying a plurality of first sustain pulses to the first electrode in a sustain period; and
applying a plurality of second sustain pulses to the second electrode while having an opposite phase to that of the first sustain pulse in the sustain period,
wherein, the plurality of first and second sustain pulses are grouped into a plurality of groups according to a pulse type, the first and second sustain pulses of a first group, which includes the first sustain pulse that is firstly applied to the first electrode in the sustain period, partially overlap, and the first and second sustain pulses of a second group among the plurality of groups do not overlap, and
the number of first and second sustain pulses included in the first group varies according to a first load ratio.

16. The method as claimed in claim 15, wherein a number of first and second sustain pulses in the first group increases relative to a number of first and second sustain pulses in the second group as the load ratio increases.

17. The method as claimed in claim 15, wherein the load ratio is calculated from an average signal level of video signals of the frame.

18. The method as claimed in claim 15, wherein the load ratio is calculated from a ratio of light emitting discharge cells in the respective subfields.

19. The method as claimed in claim 15, wherein the first and second sustain pulses alternately have a high level and a low level voltage,
a period for changing a voltage of the first sustain pulse from the high level voltage to the low level voltage overlaps a period in which the second sustain pulse applied immediately after the first sustain pulse has the high level voltage when the first and second sustain pulses of the first group overlap, and
there is no period in which the first and second sustain pulses overlap when the first and second sustain pulses of the second group do not overlap.

20. The method as claimed in claim 19, wherein a pulse type of a third group among the plurality of groups is the same as that of the first group, a pulse type of a fourth group among the plurality of groups is the same as that of the second group, and the number of first and second sustain pulses included in the third group increases relative to the fourth group as the load ratio increases.

21. A controller for use with a plasma display device, the controller comprising:
a dividing unit configured to divide one frame into a plurality of subfields;
a screen load unit configured to calculate a screen load ratio from video signals of the frame;
a ratio unit configured to determine a ratio of overlap sustain pulses and non-overlap sustain pulses in the plurality of subfields according to a load ratio; and
an arranging unit configured to arrange the sustain pulses allocated to the plurality of subfields as the overlap sustain pulses and the non-overlap sustain pulses based on the determined ratio.
